(19) United States
(12) Patent Application Publication
(10) Pub. No.: US 2004/0125467 A1
(43) Pub. Date: Jul. 1, 2004

(54) Position micro-perturbation device

(75) Inventors: Yao-Min Lin, Hsinchu City (TW); Chih-Kuang Chen, Kaohsiung City (TW); Yu-Sen Shih, Hsinchu City (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/646,795

(22) Filed: Aug. 25, 2003

(30) Foreign Application Priority Data
Dec. 27, 2002 (TW) 91137768

(51) Int. Cl. G02B 9/00

(52) U.S. Cl. 359/754

(57) ABSTRACT

A position micro-perturbation device is disclosed, comprising two wedge-shaped lenses mounted coaxially and rotatable with respect to each other to change the light path of an image and bring about position micro-perturbation. A photodetector is used to pick up the image as a result of the position micro-perturbation, and an image-processing algorithm is further used for calculation. The amount of displacement and direction of the light path of the image is freely adjustable so that the position micro-perturbation can be occurred at any position. Hence, the resolution of the photodetector is high. Furthermore, because fewer wedge-shaped lenses mounted coaxially are used, the size of the position micro-perturbation device, as a whole, can be small and achieved at reasonable cost.

### BACKGROUND OF THE INVENTION

1. Field of the Invention

The present invention relates to a position micro-perturbation device, and more particularly, to a device suitable for increasing the resolution of an image as a result of position micro-perturbation caused by rotatable wedge-shaped lenses.

2. Description of Related Art

The spatial resolution of the conventional photodetectors is improved as the number of pixels is increased. Due to the manufacturing techniques and cost, the greater the quantity of the pixels, the more expensive the system will be. On the other hand, the demand for a high-resolution photodetector has steadily increased, whereby the market trend is toward a photodetector having high resolution at low cost.

At present, there is a significant need in the industry for a method to increase the resolution of an image at low cost. A position micro-perturbation device is generally used to this end. The spatial resolution of a photodetector is improved by minimal displacement caused by the position micro-perturbation device. Plural images as a result of position micro-perturbation are used, in combination with an image-processing algorithm, to calculate and result in a subpixel effect. It is therefore common to use the position micro-perturbation device in such a method where image is incident exactly upon the place at which the pixel is equally divided into several portions (for example, the upper-left quarter of the pixel, the upper-right quarter of the pixel, the lower-left quarter of the pixel and the lower-right quarter of the pixel). Then, plural images as a result of position micro-perturbation are used, in combination with an image-processing algorithm, to calculate and achieve the subpixel effect (i.e. regenerating a calculated image with higher resolution through the assistance of virtual subpixels of smaller size). However, this method requires a device of excellent performance so that light can be incident upon the place at which the pixel is equally divided. Then, an accurate image-processing algorithm is used to calculate and achieve the subpixel effect and improve the resolution.

Prior to the present application, many researchers suggest methods for solving the aforesaid problems. In one of the suggested methods, a rotating disk having four wedge-shaped lenses and a hollow portion is used to double the resolution of the photodetectors, wherein polarized images are formed at the left, right, upper and lower portions of the four wedge-shaped lenses and an un-polarized image is formed at the hollow portion. However, the technique illustrated above requires four wedge-shaped lenses, and a large-sized rotating disk. Also, the position micro-perturbation caused by the wedge-shaped lenses can be adjusted only to the left, right, upward and downward directions, restricting the displacement of image. Thus, the application scope of this prior method is very limited. Meanwhile, as both the refraction index and inclined angle of the wedge-shaped lenses cannot be reduced it is necessary to replace the original wedge-shaped lenses with new wedge-shaped lenses for a different photodetector. On the other hand, the known position micro-perturbation device uses wedge-shaped lens having a very little inclined angle in order to bring about the effect of position micro-perturbation and accuracy in use. The wedge-shaped lens having a little inclined angle in fact is hard to be made through polishing in the manufacturing process. The size of such a lens is large, the source of supply is limited, and the cost thereof is high. Hence, the prior device lacks utility for cost-effective mass production.

Therefore, it is desirable to provide an improved position micro-perturbation device to mitigate and/or obviate the aforementioned problems.

### SUMMARY OF THE INVENTION

It is therefore an object of the present invention to provide a position micro-perturbation device to increase the resolution of image as a result of position micro-perturbation available at any position by means of rotatable wedge-shaped lenses.

Another object of the present invention is to provide a position micro-perturbation device to reduce the size of the whole position micro-perturbation device and increase the accuracy thereof at a reasonable cost.

To attain the above-mentioned objects, an improved position micro-perturbation device according to the present invention comprises a first optical lens, at least two wedge-shaped lenses which are rotatable and mounted adjacent to the first optical lens, and a photodetector for receiving light emitted from both the first optical lens and the wedge-shaped lenses, wherein the wedge-shaped lenses are mounted between the first optical lens and the photodetector, the image passing through the first optical lens is incident upon the photodetector by the wedge-shaped lenses, which are then rotated to cause position micro-perturbation by displacing the image incident upon the photodetector.

The position micro-perturbation device of the present invention is characterized in that the image from the first optical lens is incident upon the photodetector adjacent to the first optical lens by means of the wedge-shaped lenses and that the effect of position micro-perturbation as well as the increase of image resolution are achieved by displacing the image incident upon the photodetector with rotatable wedge-shaped lenses. The position micro-perturbation device of the present invention may further comprise a second optical lens mounted between the wedge-shaped lenses and the photodetector to focus the light or image from the wedge-shaped lenses to be incident upon the photodetector.

In addition, the present invention may further comprise at least two rotating disks to mount the wedge-shaped lenses thereon respectively for rotation. Also, at least one driving unit for driving the rotation of the respective rotating disks as well as the wedge-shaped lenses can be used. The wedge-shaped lenses can be rotated in either the same or opposite direction to change the light path of the image from the first optical lens to be incident upon an adjacent position. The wedge-shaped lenses can be rotated over a full 360 degree range. The inclined angle between the light-incident plane and the lateral surface of each wedge-shaped lens of the present invention can be any angle less than 90 degrees. Preferably, the inclined angle between the light-incident plane and the lateral surface of each wedge-shaped lens is less than 30 degrees. The quantity of the plural wedge-shaped lenses is not particularly specified, and can be increased or decreased as necessary. Preferably, two wedge-shaped lenses are used.

Accordingly, any point of an original image or any position reflected from an object can be shifted to the predetermined inclined angle or to the predetermined location of the photo-detector through the assistance of the position micro-perturbation of the present invention by rotating the respective wedge-shaped lenses. Thus, an image is freely movable on a two-dimensional (2D) plane. Also, the amount of displacement and direction of the wedge-shaped lenses are freely adjustable by the rotation thereof and the predetermined inclined angle thereof. Furthermore, the amount of the displacement of the 2D image can be easily made within in a pixel so as to achieve the object of increasing the resolution of image. Meanwhile, the position of the axis of the rotatable wedge-shaped lenses is not particularly specified, and preferably, the wedge-shaped lenses are mounted coaxially (namely, the rotation axes of the wedge-shaped lenses are set on the same axial line). Hence, the size of the position micro-perturbation device, as a whole, can be reduced at reasonable cost.

Other objects, advantages, and novel features of the invention will become more apparent from the following detailed description when taken in conjunction with the accompanying drawings.

### BRIEF DESCRIPTION OF THE DRAWINGS

FIG. 1 is a view of the construction of the present invention;

FIG. 2A is a schematic view of the change of the light path of the first wedge-shaped lenses according to the present invention;

FIG. 2B is a schematic view of the displacement trace caused by the change of the light path as shown in FIG. 2A;

FIG. 3A is a schematic view of the change of the light path of the first wedge-shaped lens as shown in FIG. 2A and the second wedge-shaped lens; and

FIG. 3B is a schematic view of the displacement trace caused by the change of the light path as shown in FIG. 3A.

### DETAILED DESCRIPTION OF THE PREFERRED EMBODIMENT

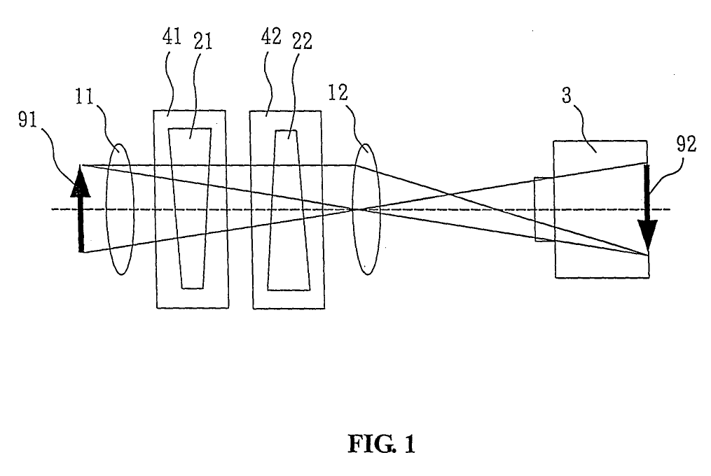

Referring now to FIG. 1, the present inventioncomprises a first optical lens 11; two wedge-shaped lenses 21, 22 both of which are rotatable and mounted adjacent to the first optical lens 11; a second optical lens 12 mounted adjacent to the wedge-shaped lenses 21, 22 so that the wedge-shaped lenses 21, 22 are placed between the first optical lens 11 and the second optical lens 12; and a photodetector 3 mounted outwardly adjacent to the second optical lens 12. The inclined angle between the light-incident plane and the lateral surface of each wedge-shaped lens of this embodiment is less than 30 degrees.

In the present embodiment, the photodetector 3 is a charge-coupled device. Furthermore, two rotating disks 41, 42 can be used to mount respectively the wedge-shaped lenses 21, 22 thereon. A driving unit (not shown) can be used to drive the rotating disks 41, 42 as well as the wedge-shaped lenses 21, 22 to be rotated over a full 360 degree range. The driving unit used in the present invention can be a step motor. Nevertheless, another device equivalent to the step motor can be applied to the present invention.

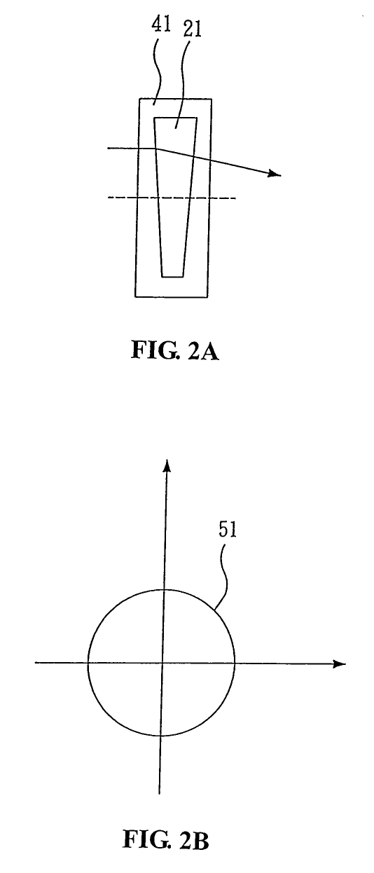

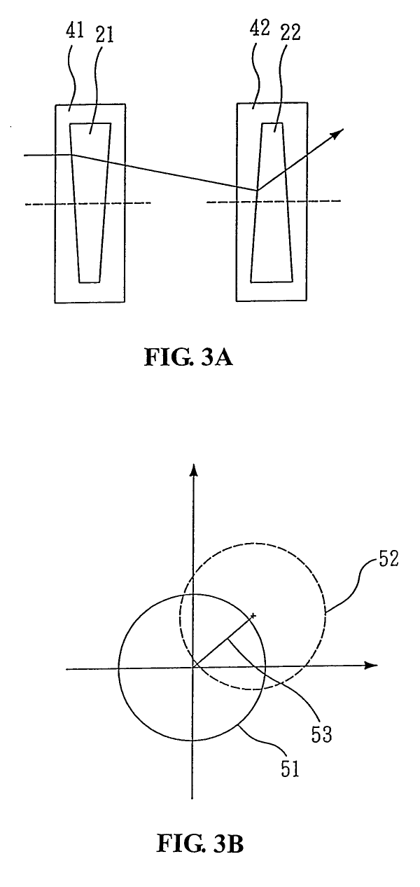

Referring simultaneously to FIGS. 1, 2A and 2B, a light path of light spot is refracted by the wedge-shaped lens 21when the light spot of an image 91 from the first optical lens 11 passes through the first wedge-shaped lens 21. Since the wedge-shaped lens 21 can be rotated over a full 360 degree range, the light spot incident upon the next optical element (such as the surface of the second wedge-shaped lens 22) causes displacement. When the wedge-shaped lens 21 rotates, the light spot incident upon the next optical element causes a trace. The trace then forms a first circle 51 on the 2D plane because of the change of position. Referring simultaneously to FIGS. 1, 3A and 3B, the light spot is then refracted again by the second wedge-shaped lens 22, similar to the refraction caused by the wedge-shaped lens 21. Thus, the light spot forms a second circular trace 52. As such, a relative rotation angle 53 is formed between the first circular trace 51 and the second circular trace 52. Finally, an image 92 is formed within the photodetector 3 by focusing image 91 with the second optical lens 12. Under such circumstances, after refractions of image 91 caused by the wedge-shaped lenses 21, 22 of the present invention, the various displacement traces of the light spot of the image can be representative of two circles. With the rotation of the respective wedge-shaped lenses 21, 22 and the adjustment of the predetermined included angles a, b of the wedge-shaped lenses 21, 22, the position micro-perturbation of image 91 is freely movable at any position and widely on the 2D plane. Hence, to displace the image on the photodetector to a subpixel distance, a minor adjustment of the relative angle of the two wedge-shaped lenses can achieve the displacement of the light spot or the image to a subpixel distance. The amount of the displacement is controlled by the rotation angle of the wedge-shaped lens. Hence, the minimal displacement of the image or light spot can be accurately obtained by adjusting the rotation angle of the wedge-shaped lens. Furthermore, the predetermined included angles a, b of the wedge-shaped lenses 21, 22 can cause the image to result in position micro-perturbation to a wide extent. In this connection, the position micro-perturbation of image 91 can be of less than one pixel. Then, an image-processing algorithm is used to effectively increase the resolution of the photodetector 3.

In addition, each of the wedge-shaped lenses 21, 22 is mounted coaxially on the rotating disks 41, 42. Therefore, the size of the position micro-perturbation device, as a whole, is reduced, as compared with the conventional devices. Also, the present invention uses fewer wedge-shaped lenses 21, 22 than the prior art. Thus, the cost can be reduced accordingly.

The present embodiment adopts two wedge-shaped lenses 21, 22. In practice, more wedge-shaped lenses can be used as necessary.

Although the present invention has been explained in relation to its preferred embodiment, it is to be understood that many other possible modifications and variations can be made without departing from the spirit and scope of the invention as hereinafter claimed.

What is claimed is:

1. A position micro-perturbation device, comprising:
a first optical lens;
at least two wedge-shaped lenses which are rotatable and mounted adjacent to said first optical lens; and
a photodetector for receiving light emitting from both said first optical lens and said wedge-shaped lenses;
wherein said wedge-shaped lenses are mounted between said first optical lens and said photodetector, the image passing through said first optical lens is incident upon said photodetector by the deflection of said wedge-shaped lenses, and said wedge-shaped lenses being then rotated to cause position micro-perturbation by displacing the image incident upon said photodetector.

2. The position micro-perturbation device of claim 1, further comprising a second optical lens mounted between said wedge-shaped lenses and said photodetector to focus the light or image from said wedge-shaped lenses on said photodetector.

3. The position micro-perturbation device of claim 1, further comprising at least two rotating disks to mount said wedge-shaped lenses thereon.

4. The position micro-perturbation device of claim 3, further comprising at least one driving unit for driving the rotation of said rotating disks.

5. The position micro-perturbation device of claim 4, wherein said driving unit is a step motor.

6. The position micro-perturbation device of claim 1, wherein said wedge-shaped lenses can be rotated in opposite directions to change the light path of the image from said first optical lens to be incident upon an adjacent position.

7. The position micro-perturbation device of claim 1, wherein said wedge-shaped lenses can be rotated over a full 360 degree range.

8. The position micro-perturbation device of claim 1, wherein said photodetector is a charge-coupled device.

9. The position micro-perturbation device of claim 1, wherein said wedge-shaped lenses are mounted coaxially.

10. The position micro-perturbation device of claim 1, wherein the inclined angle between the light-incident plane and the lateral surface of each wedge-shaped lens is less than 30 degrees.
